(19) United States
(12) Patent Application Publication
(10) Pub. No.: US 2017/0037260 A1
(43) Pub. Date: Feb. 9, 2017

(54) Photo-Activated Polymers and Use in Articles, and Methods of 2D and 3D Printing

(71) Applicant: Printscape Solutions, LLC, Cary, IL (US)

(72) Inventors: Matthew S. Northam, Cary, IL (US); Narayan S. Hosmane, DeKalb, IL (US)

(21) Appl. No.: 15/230,141

(22) Filed: Aug. 5, 2016

Related U.S. Application Data
(60) Provisional application No. 62/201,459, filed on Aug. 5, 2015.

(51) Int. Cl. C09D 5/29; B05D 5/06; C09D 201/00; B33Y 70/00; C09D 165/00; C09D 125/04

(52) U.S. Cl. CPC C09D 5/29; C09D 165/00; C09D 125/04; C09D 201/005; B33Y 70/00; B05D 5/06

(57) ABSTRACT

Photo-activated polymers and co-polymers exhibit colors in the visible spectrum when photo-activated. The photo-active polymers, co-polymers and combinations thereof may be utilized in articles to impart color to the articles. For example, the photo-active polymers may be utilized in printing technology, such as in 2D printing and/or in 3D-printing methods to impart colors to articles.

### TECHNICAL FIELD

Photo-activated polymers and/or co-polymers exhibit colors in the visible spectrum when photo-activated. The photo-active polymers, co-polymers and combinations thereof may be utilized in articles to impart color to the articles. For example, the photo-active polymers may be utilized in printing technology, such as in 2D printing and/or in 3D-printing methods to impart colors to articles.

### BACKGROUND

The use of inks, dyes and pigments goes back millennia to the dawn of humankind. Specifically, it is well known to extract inks, dyes and pigments from various natural materials, such as minerals, plants and animals. For example, it was well-known around the Mediterranean region since at least the 15^{th} century B.C.E. that a purple pigment could be extracted from a sea snail called the spiny dye-murex and utilized to color fabrics. Over the years, many different natural and man-made materials have been utilized to create colored inks, dyes and pigments.

In the modern era, many products are made from polymeric materials and are often colored using dyes and pigments. It is also generally known to utilize polymers that themselves exhibit a color, although it has been generally easier to simply color polymers using dyes and pigments. Indeed, most consumer products exhibit some color to make the products more aesthetically pleasing, or even impart a functional property.

3D printing is a relatively new way to manufacture articles using polymers or other materials. Many types of 3D printers exist in the marketplace, but in general most utilize an additive methodology, where a print-head deposits a thin layer of polymeric, metallic, or other material to build an article. In most 3D printers on the market, a print-head is fed a filament of polymer or other material that is then melted and deposited in successive thin layers to form the article, which cools and hardens. Alternatively, liquid polymeric material may be deposited and photocured, thereby hardening as it is deposited.

Typically, to impart a color or a plurality of colors to a 3D printed article, the polymer resin from which the article is printed contains a dye or pigment. In traditional 3D printers, an article is typically made from a single polymeric material, in which case if the polymeric material is dyed or pigmented, then the article itself typically is a single color. However, more recently 3D printers have utilized a plurality of polymeric sources to print articles. Therefore, different polymeric materials and/or different colors may be utilized to create a 3D printed article having a plurality of colors. To utilize a plurality of different polymeric materials and/or different colors, multiple print-heads are typically used. However, the use of multiple print heads tends to be cumbersome and difficult to use. Moreover, the use of multiple print-heads may significantly slow the 3D printing process. A need exists for a method of imparting color to articles without requiring different polymeric materials. Moreover, a need exists for a method of imparting color to articles without requiring multiple print-heads. In addition, a need exists for a method of imparting color to articles that is easy to use, and is relatively fast.

Moreover, the use of dyes and/or pigments in polymers leads to undesirable results. Dyes and pigments may not be photo and heat stable, may be difficult to disperse within polymeric material, may migrate after deposition, may be costly and may be difficult to handle. Moreover, dyes and pigments may be ecologically unsafe, as many dyes and pigments are toxic and may migrate into the environment. A need, therefore, exists for colored polymers that may be used in articles without using dyes or pigments. Specifically, a need exists for colored polymers that may be photo-active whereby the color of the polymer is imparted using radiation. Moreover, a need exists for colored polymers that are environmentally friendly and non-toxic.

### SUMMARY OF THE INVENTION

The present invention relates to photo-activated polymers and co-polymers that exhibit colors in the visible spectrum when photo-activated. The photo-active polymers, co-polymers and combinations thereof may be utilized in articles to impart color to the articles. For example, the photo-active polymers may be utilized in printing technology, such as in 2D printing and/or in 3D-printing methods to impart colors to articles.

To this end, in an embodiment of the present invention, a method of making an article is provided. The method comprises: depositing a polymer precursor molecule as a liquid, and polymerizing the polymer precursor molecule with a color inducing molecule to form a copolymer having a color imparted by the color inducing molecule. In an embodiment, the method comprising a printing method of making the article. The printing method comprises a 2D printing method. Alternatively, the printing method comprises a 3D printing method.

In an alternate embodiment of the present invention, a method of making an article is provided. The method comprises: depositing a polymer precursor molecule as a liquid having at least one chromophore associated therewith, and polymerizing the polymer precursor molecule to form a polymer having a color imparted by the at least one chromophore.

It is, therefore, an advantage and objective of the present invention to provide a method of imparting colors to articles without requiring different polymeric materials.

Moreover, it is an advantage and objective of the present invention to provide a method of imparting colors to articles without requiring multiple print-heads.

In addition, it is an advantage and objective of the present invention to provide a method of imparting colors to articles that is easy to use, and is relatively fast.

Further, it is an advantage and objective of the present invention to provide colored polymers that may be used in articles without using dyes or pigments.

Specifically, it is an advantage and objective of the present invention to provide colored polymers that may be photo-active whereby the color of the polymer is imparted using radiation.

Moreover, it is an advantage and objective of the present invention to provide colored polymers that are environmentally friendly and non-toxic.

Additional features and advantages of the present invention are described in, and will be apparent from, the detailed description of the presently preferred embodiments and from the drawings.

### DETAILED DESCRIPTION OF THE PRESENTLY PREFERRED EMBODIMENTS

The present invention relates to photo-activated polymers and/or co-polymers that exhibit colors in the visible spectrum when photo-activated. The photo-active polymers, co-polymers and combinations thereof may be utilized in articles to impart color to the articles. For example, the photo-active polymers may be utilized in printing technology, such as in 2D printing and/or in 3D-printing methods to impart colors to articles.

More specifically, polymers and/or copolymers are utilized in photopolymerization methods to create 2D and 3D articles. Specifically, photopolymerization typically involves utilizing a radiation source to rapidly cure one or more monomers or short-chain polymers or copolymers in a liquid state to form a solid polymer. In 2D printing, a monomer or relatively short-chain polymer or copolymer may be applied to a surface as a liquid and exposed to a radiation source, such as infrared, visible or ultraviolet light of a specific wavelength or range of wavelengths, whereupon the monomer or relatively short-chain polymer or copolymer may cure and solidify. In 3D printing, a monomer or relatively short chain polymer or copolymer may be applied as a layer and exposed to a radiation source for curing, and further layers may be additively applied, each layer being cured successively. Varying techniques are utilized for creating a 3D article using photopolymerization, but each technique utilizes the same principle of applying a liquid monomer or short-chain polymer or copolymer as a liquid and polymerizing the monomer or short-chain polymer or copolymer to form a solid 3D article.

The present invention utilizes a color emitting polymer or copolymer that may be or may be incorporated into a polymer backbone utilized in photopolymerization printing methods such that when exposed to a radiation source of a wavelength or range of wavelengths, expresses a color that is visible. In an embodiment, the polymer or copolymer may be applied and exposed to a wavelength or range of wavelengths that both cure the polymer or copolymer and causes the polymer or copolymer to express a particular color. For example, a polymer or copolymer may be utilized that expresses blue when exposed to a specific wavelength or range of wavelengths. Likewise, a polymer or copolymer may be utilized that expresses red when exposed to a specific wavelength or range of wavelengths. Moreover, a polymer or copolymer may be utilized that expresses green when exposed to a specific wavelength or range of wavelengths. The colors may be applied to an article in various locations and combined to create any desired color in the RGB palette.

Any radiation may be utilized to create a color-expressing polymer or copolymer. Preferably, infrared, visible or ultraviolet radiation may be utilized. More preferably, infrared and ultraviolet radiation may be utilized, as polymer or copolymer requiring visible light to express different colors may be prone to color shifting or fading. Most preferably, ultraviolet radiation may be utilized. Moreover, a protective layer may be applied over the article to prevent ambient radiation, such as ambient infrared, visible or ultraviolet radiation from causing a color shift or color fading. Preferably, an ultraviolet blocking layer may be applied over an article made from polymer or copolymer that expresses a color upon exposure to ultraviolet radiation of a specific wavelength or range of wavelengths.

In an alternate embodiment, a polymer or copolymer may be deposited on a surface, such as in a 2D printing method or additively in a 3D printing methodology in a manner not requiring radiation for curing the same. For example, a polymer or copolymer may be melted and deposited on a surface whereupon the polymer or copolymer may harden when cooled. Thereafter, the hardened polymer or copolymer may be exposed to radiation of a wavelength or range of wavelengths, and/or intensity to cause the polymer or copolymer to crosslink or otherwise cure to express a color as desired. Thus, the radiation may only be used for expressing the color and not for curing the polymer, as described herein.

Alternatively, a polymer or copolymer may be cured using a wavelength or range of wavelengths and thereafter exposed to a different wavelength or range of wavelengths, and/or intensities of radiation to cause a color to express. In such a situation, the curing wavelength or range thereof of the polymer or copolymer may be different than the color expressing wavelength or range thereof, and therefore the polymer or copolymer may be exposed to radiation twice at different wavelengths or ranges thereof to both cure and express a desired color.

In a preferred embodiment, the same polymer or copolymer may be utilized to express different colors when exposed to different wavelengths or ranges of wavelengths and/or different intensities of radiation. Thus, when utilized in a printing technology, such as in 2D or 3D printing, a single polymer source may be utilized to provide both the structure and the color of the article, with the color varying based on wavelength and/or intensity of the radiation applied thereto after deposition.

Alternatively, different polymers or copolymers may be utilized to express the different colors. When utilized in a 2D or 3D printing process, the different polymers or copolymers from different source vats may be deposited and exposed to the specific wavelength or range of wavelengths and/or intensities of radiation to cure the same and express the desired color. In an alternate embodiment, the printing methodology may utilize a combination of the same polymer or copolymer, exposed to different ranges and/or intensities of radiation, and different polymers or copolymers.

In an exemplary embodiment, an article may be made having a surface to which colors may be applied. One or more liquid monomers or short-chain polymers or copolymers may be deposited on the surface thereof utilizing a 2D printing method in a pattern or in a particular field (such as in a 2D shape, such as a square or rectangle, forming a surface to which radiation may be imparted), whereupon the monomers or short-chain polymers or copolymers are subsequently exposed to a wavelength or range of wavelengths of curing radiation that also causes the polymer or copolymer to express one or more colors. If a pattern is deposited on the surface, then only the pattern may express the desired color when exposed to radiation. If a field is deposited on the surface of the article, then the field may be exposed in various locations to different wavelengths or ranges of wavelengths and/or for differing intensities to cause the polymer or copolymer to express a desired color. The colors may be expressed in specific discrete locations to cause the colors to form a pattern on the deposited field.

In another exemplary embodiment, one or more polymers or copolymers may be utilized to form a 3D printed article using standard 3D printing methods. Specifically, a 3D printed may deposit one or more monomers or short-chain polymers or copolymers in liquid form to a surface and expose the deposited monomers or short-chain polymers to a specific wavelength or range of wavelengths to cure into a polymer expressing a particular color. In an embodiment, the polymer or copolymer may comprise a plurality of functional color imparting elements, such as copolymer or chromophores, as described in the examples below, so that the polymer may express one color when exposed to a specific wavelength or range of wavelengths, but a different color when exposed to a different wavelength or range of wavelengths.

In an embodiment of the present invention, a 3D printer utilizes the polymers or copolymers, as described herein, to create 3D articles having one or more colors, without the use of inks, dyes or pigments. The 3D printer may utilize a radiation imparting array that may easily radiate specific wavelengths, ranges of wavelengths and/or intensities, as needed.

Preferably, a photopolymer may be utilized that in a 2D or 3D printing methodology. The photopolymer may be chemically changed to incorporate a color expressing functional group, such as a chromophore, or to create a color expressing copolymer. The color expressing portion may be reversible, such as through a cis to trans or closed to open conformational changes. Alternatively, the color expressing portion may be irreversible, such as via crosslinking or the like. Any polymer types may be utilized herein, including but not limited to conjugated and non-conjugated polymer types.

The following are examples of copolymers that may be utilized in the present invention to allow an article to express one or more colors without the use of inks, dyes or pigments.

### EXAMPLES

Polyfluorene is a polymer that expresses a color in the blue region of the visible spectrum, and is known to be copolymerized to show a red shift in its coloring range to produce a green color or even a red color. Acrylate resins are typical resins that may be utilized in photopolymerization 3D printing methods. The acrylates may also be relatively easily modifiable to copolymerize with color-expressing copolymers, as described in more detail below.

### Example 1

### Blue Emitting Copolymer A

Polyfluorene with phenanthro[9,10-d]imidazole group shows strong blue color in its solid state. Specifically, Compound 2, below, may be synthesized using a derivative of polyfluorene and the commercially available 4-(bromomethyl)phenylboronic acid. The resulting product (2) may be copolymerized with tert-butyl acrylate (TBA) to produce the final Copolymer A, as shown below:

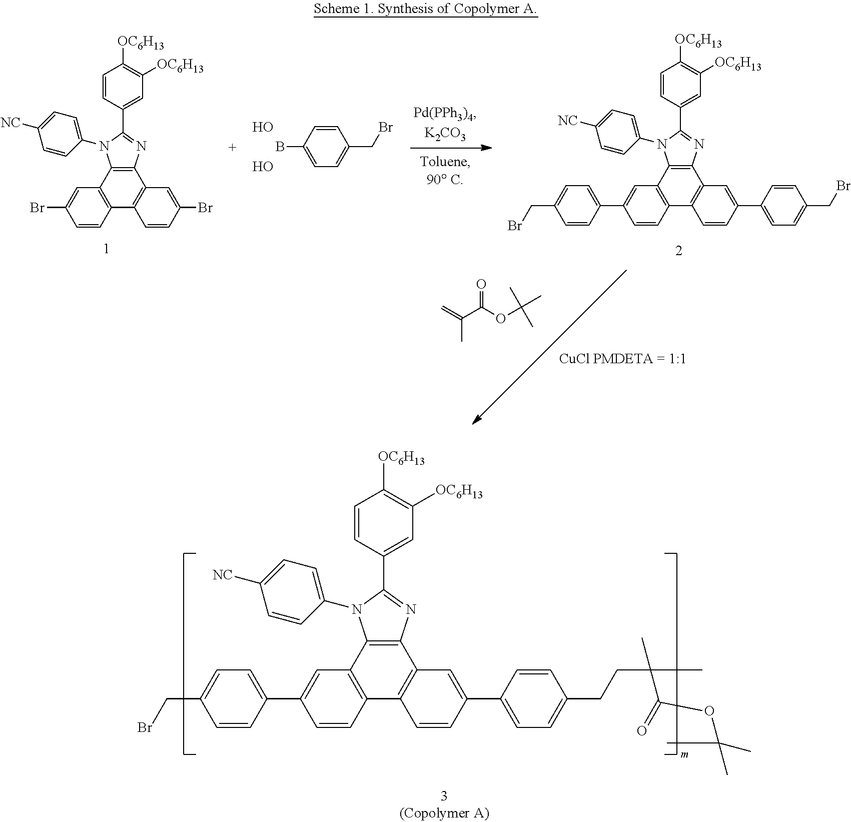

### Example 2

### Red Emitting Copolymer B

Synthesis of red-emitting polyflourene based copolymer may be done by introducing 20pyran-4-ylidene-malononitrile moiety to the TBA polymer backbone. The 2-pyran-4-ylidene-malononitrile moiety has been observed to be useful to general a relatively good red-emitting property to the polyfluorene polymers. Scheme 2, below, illustrates a possible synthesis of a fluorine-acrylate Copolymer B:

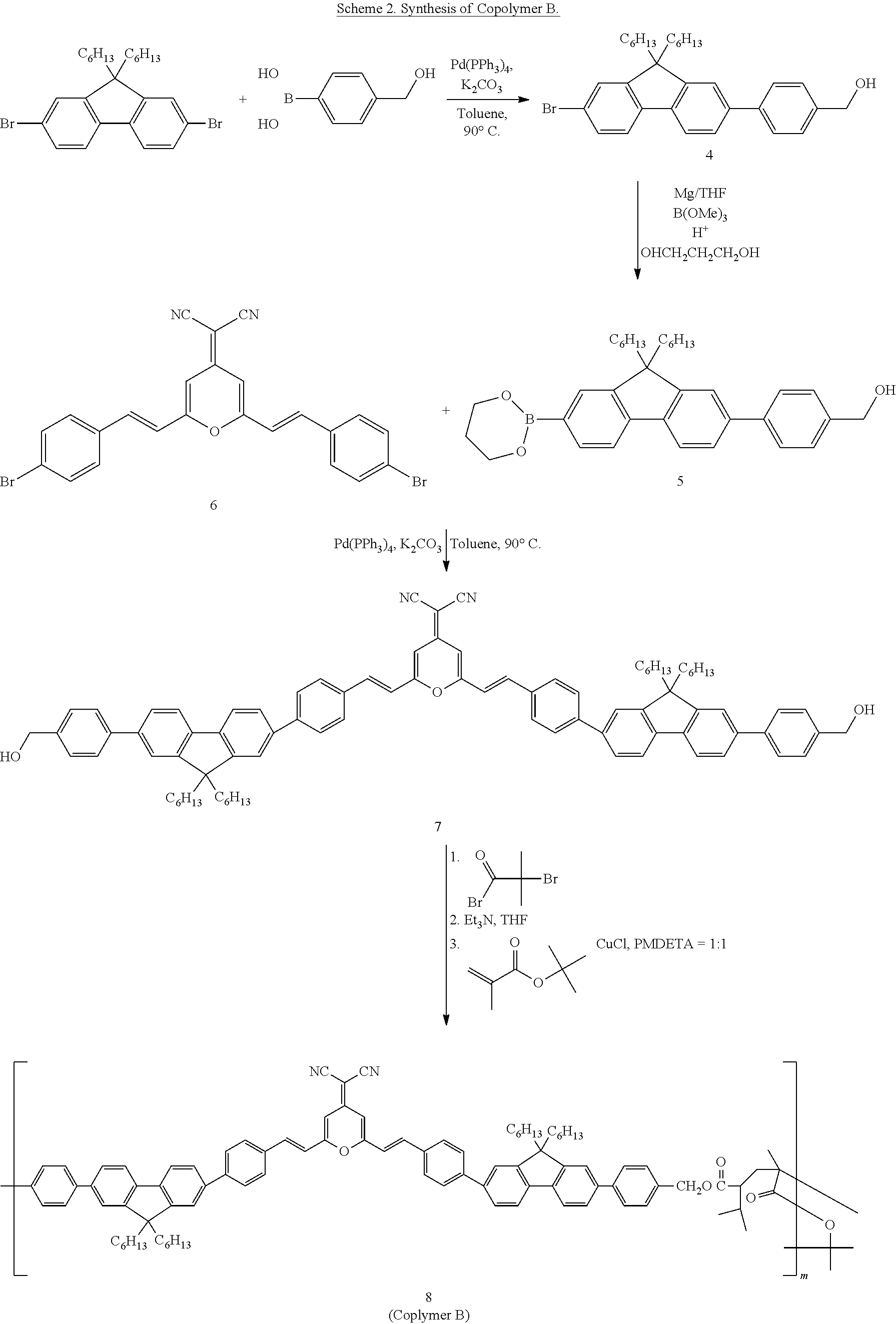

In Scheme 2, above, Compound 4 may be synthesized via a Suzuki coupling reaction of the commercially available 9,9-dihexyl-2,7-dibromofluorene and 4-(hydroxymethyl)phenylboronic acid. The 2-{2,6-Bis[2-(4-bromophenyevinyl]pyran-4-ylidene}-malononitrile (Compound 6), synthesized as shown in Scheme 3, may then react further via another Suzuki coupling reaction with Compound 5 to form Compound 7, which is the fluorene-derivative with the 2-pyran-4-ylidene-malononitrile moiety incorporated in the monomer backbone. Copolymerization with TBA produces Compound 8 (Copolymer B).

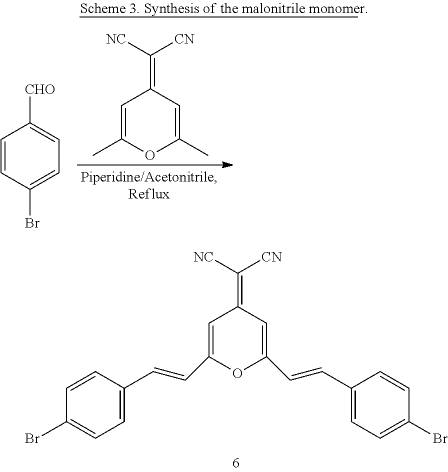

Compounds A and B may be copolymerized in a photopolymerization 3D printing methodology, as described herein. When polymer precursor molecules are deposited as a blend in a liquid state, the copolymerization may occur via exposure to a specific wavelength or range of wavelengths of radiation as necessary to cure and create the color expressing copolymers. For example, in a single 3D printing system, the liquid precursors to Copolymers A and B may be deposited and exposed to the proper radiation to create the synthesized and cured Copolymers A and B, thereby creating the article and colors thereon.

### Example 3

### Photo-Activated Styrene Star Polymers

In a further example, 3D photo-activated styrene star polymers may be utilized to create polymer architecture in 3D printing systems to create articles having desired expressed colors without inks, dyes or pigments. The following terminology applies to the use of these materials:

Core: A metal or metalloid atom, molecule or macromolecule that is a centralized moiety to chemically connect polymer arms. Boron Subphthalocyanine chloride (Cl-BSubPc) and Boron Subphthalocyanine azide, as shown in Scheme 4 and Scheme 5, below, are examples of metaloid molecules that may be utilized as star polymer cores. The symmetrical 14π-electron system of BsubPc absorbs and emits radiation in the visible spectrum generally between 560-600nm. This radiation is perceived as orange to magenta emission to the human eye.

Arm: A polymer chain that connects to a core on one end and can be functionalized with a pendent group on the other end.

Star Polymer: A polymer with three or more linear polymer chains radiating from a central multifunctional moiety (“core”) to which they are chemically attached. The linear chains can be chemically attached either by coupling or by being grown from that core during the polymerization step.

Dendritic Polymer: A highly structured spherical polymer grown in successive generations from a central core. Every monomer in a generation contains a branch point and allows the attachment of one or more units in the next generation.

Although this example refers to star polymer architecture for 3D printing applications, it should be noted that dendritic polymers may also be utilized as an alternative polymer architecture. Dendritic polymers may have additional applications as a core for star polymers. Methods of Preparing Homo Star Polymers

There are, generally, three methods for the preparation of star polymers: core first, arm first, and “couple onto” processes. The “core first” process uses a well-defined initiator with a known number of initiating groups or a less defined multifunctional macromolecule. Scheme 4, below, illustrates the synthesis of Cl-BSubPc core molecule with chlorine initiator sites. These chlorine initiator groups are able to conduct and control the polymerization of the styrene arms in a more systematic approach. The BSubPc core could alternatively replace the chlorine initiators with azide to create azide-BSubPc. This may allow the coupling of the arm to the core using “click” chemistry. 1-chloro-4,5-dicyanobenzene may react with acetone and sodium azide to substitute the chlorine functional groups, as shown in Scheme 5, below. The styrene polymeric arms would require an alkyne terminating group for the “click” reaction to be able to react with the azide-BSubPc core.

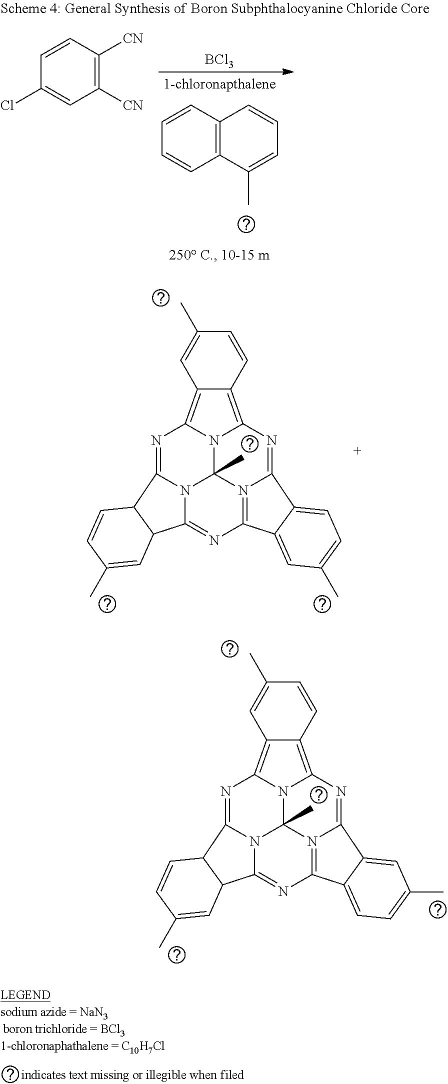

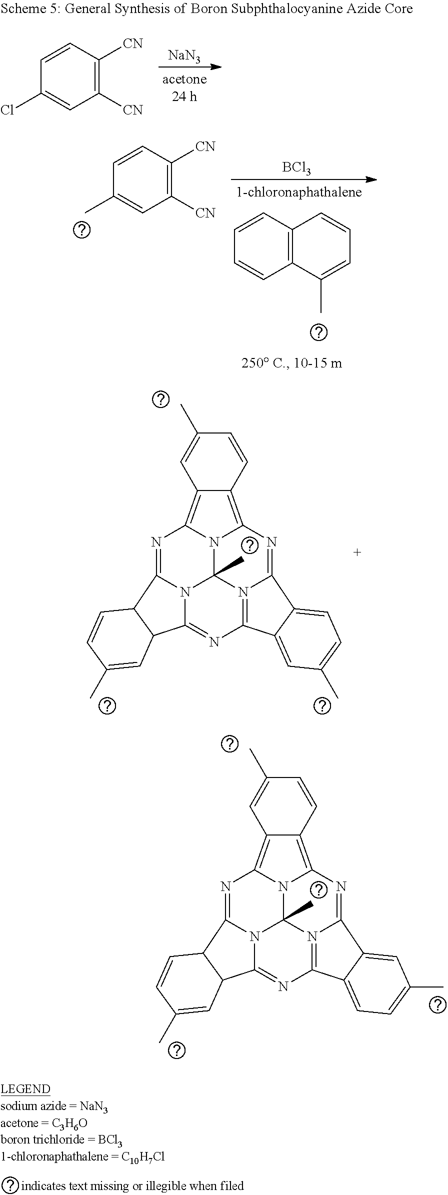

### Synthesis of Homostar and Heterostar Polymers

There are many types of polymer and core combinations that may be utilized for synthesis and design of star polymer systems. Boron subphthalocyanine chloride cores with poly(styrene) arms are preferred. However, poly(L-lactide) arms or other polymer arms and cores may alternatively be utilized. Utilizing a “core-first” synthesis approach, the arms may be chemically grown in a more controlled fashion allowing of the best property-structure study, enabling characterization of the polymer material. Successful polystyrene star polymers are shown in Scheme 4, above, with poly(divinylbenzene), sucrose, glucose, cyclodextrin, trithiocarbone heptafunctional β-cyclodextrin ring, polyhedral oligomeric silsesquioxane (POSS), plurality of sulfonyl chloride groups, 1,1,1-tris(4-hydroxphenyl)ethane and porphyrin utilized as cores. Successful PLLA star polymers are synthesized with sorbitol, POSS, polyethylenimine (PEI), glycerol, pentaerythritol (PE), dipentaerythritol (DPE), trimethylolpropane) TMP), diTMP and erythritol, xylitol, inositol and tripentaerythritol (TPE) cores.

Functionalization of the Arms of the Star Polymer with Chromophore Pendent Group

Scheme 6, below, shows a Cl-SubPc core arms polymerizing from hexakis(chloromethyl)benzene monomers with benzoyl peroxide initiator:

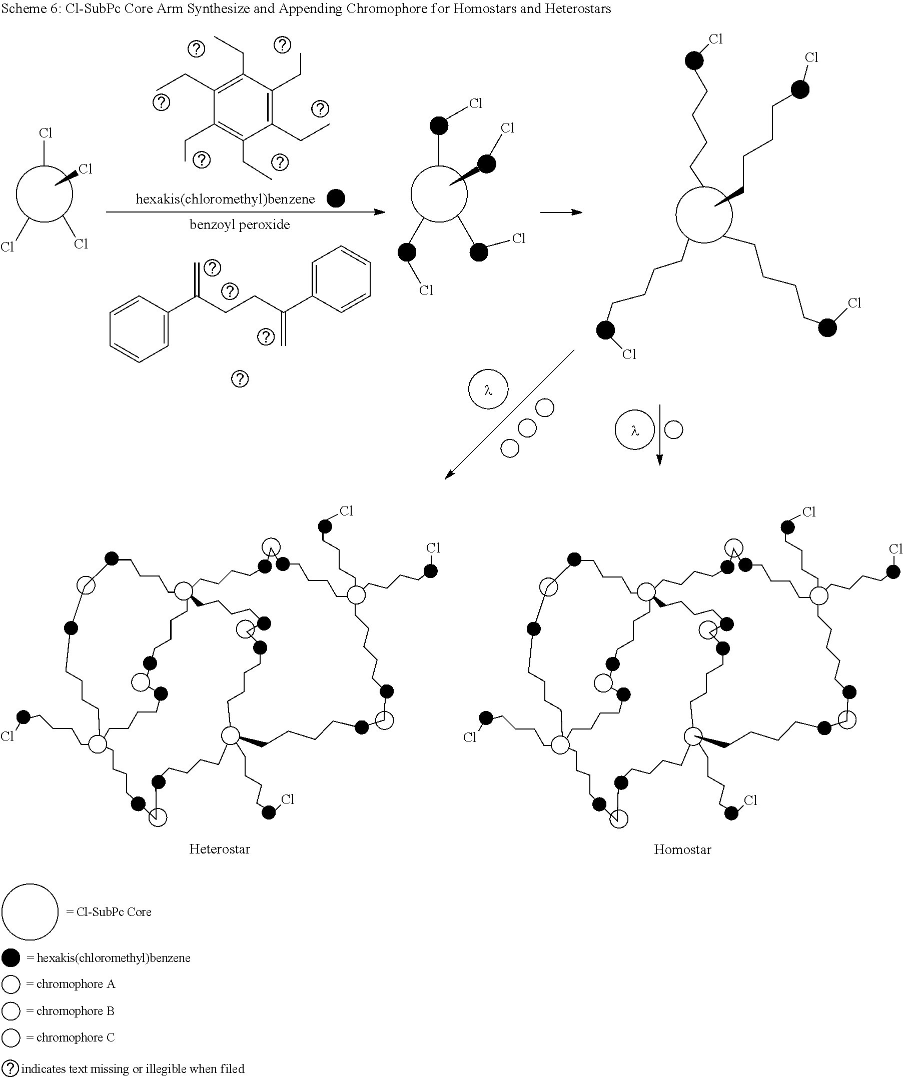

After the poly(styrene) (or poly(L-lactide)) arms are synthesized with a reactive terminating group, that arm can be functionalized with a chromophore. The chromophore is preferably doped into the polymer matrix and may react with ultraviolet light or infrared light. It may be beneficial for the chromophore to break a bond and degrade at a certain wavelength and crosslink the polymer arms. The chemical cross-linking of the polymer would classify the material as a thermoset resin. Another way to produce color may be for the chromophores to form dimers or trimers on exposure to radiation without crosslinking with the polymer arms. Alternatively, another monomer or arm chemistry can be used as a cross-linker for star-star coupling for free radical polymerization between star groups. Specific red, green and blue chromophores may functionalize the arms of the star polymer with BSubPc cores, as disclosed herein.

Combination of Chromophore Arm Types into Heterotype Star Polymer

The next step after successful creation of photosensitive homostar polymer containing chromophores of a single chemistry, as shown in Scheme 6, is to make a heterostar polymer. The heterostar polymer may have one or more type of chromophore, as demonstrated in Scheme 6. Additional chromophores may make the polymer sensitive to additional wavelengths. Thus, the activation of more than one chromophore may create a range of intermediate colors observable in the polymeric material.

Increasing Light-Harvesting and Energy Transfer with BSubPc Core Star Polymers

π-conjugated chromophores may be utilized by using an atactic polystyrene copolymer with oligo(phenylene-ethylene) (OPE) and thiophene-benzothiadiazole (TBT) pendent groups. The energy transfer of such a process is between 2-4 ps due to site-site neighboring OPE-TBT pendent groups. Energy transfer yields with 85.7% to 94.9% were observed related to TBT content from 5.4% to 20% of polymer. A star polymer architecture may create a more efficient light energy chromophore transfer system. The star polymer may preferably remove the need for the polystyrene to be atactic and increasing the amount of arms, thus improving the transfer rate and offer a higher photoluminescence. Furthermore, a non-conjugated polystyrene polymer may be utilized because conjugated polymers may be plagued with conformational disorder. The conformational disorder may break the polymer into a series of chromophore segments with different conjugated lengths. Varying conjugated lengths may result in excited-state dynamics characterized by self trapping, limited to excited diffusion lengths of 10 nm and low quantum yields. Star polymer architecture may improve the conformational disorder of conjugated polymers and offer a more uniform conjugated length distribution, specifically if the arms are synthesized and then attached to the central moiety. Alternatively, an inert stabilization arm may be placed adjacent to the conjugated polymer arm to prevent unwanted interactions between two conjugated bulky polymer arms, illustrated below in Scheme 7:

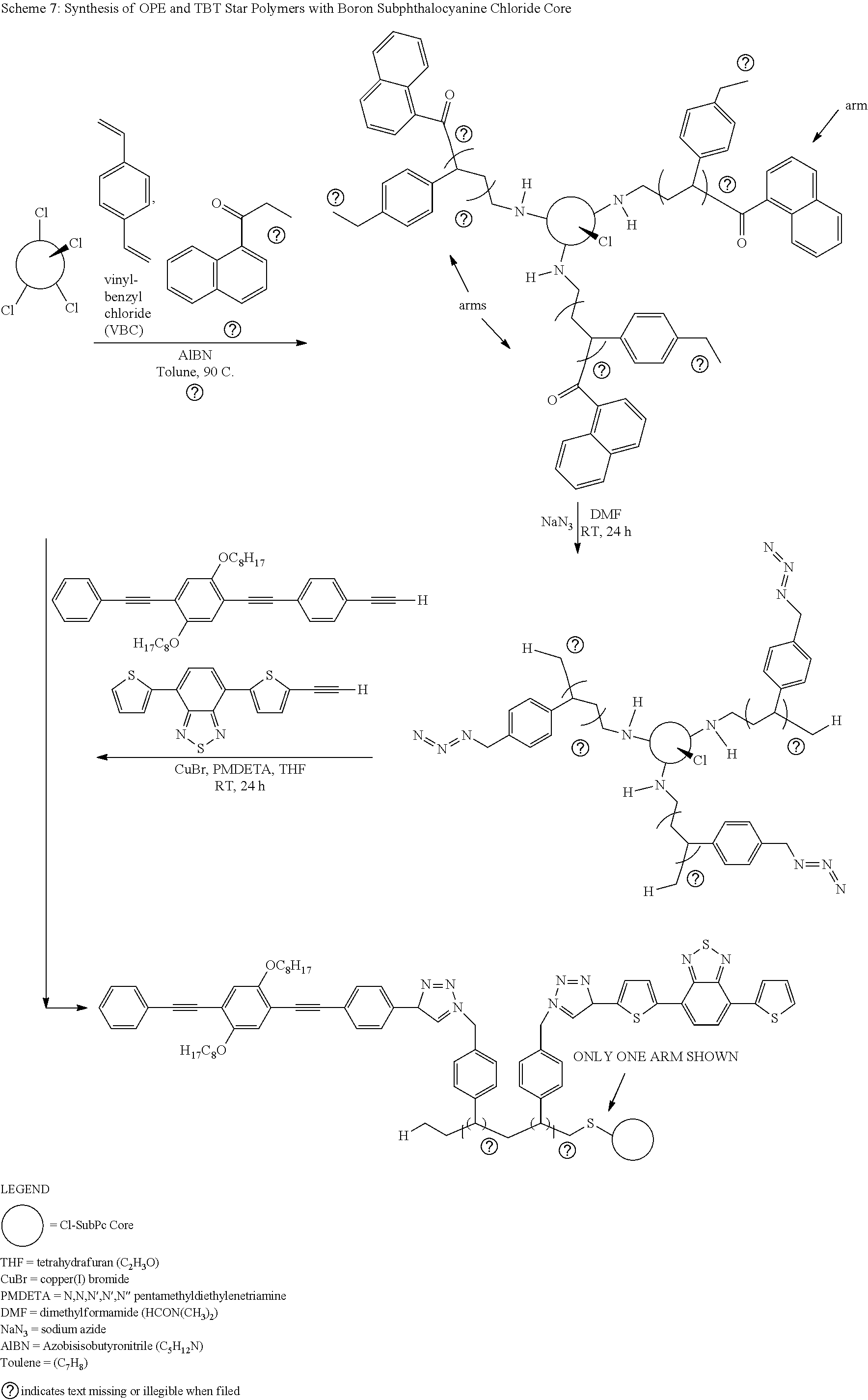

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A method of making an article comprising the steps of:
depositing a polymer precursor molecule as a liquid; and
polymerizing the polymer precursor molecule with a color inducing molecule to form a copolymer having a color imparted by the color inducing molecule.
